(19) United States
(12) Patent Application Publication
(10) Pub. No.: US 2022/0250995 A1
(43) Pub. Date: Aug. 11, 2022

(54) High Emissivity Cerium Oxide Coating

(71) Applicant: SCG Chemicals Co., Ltd, Bangkok (TH)

(72) Inventors: Jaturong Jitputti, Bangkok (TH); Koichi Fukuda, Tokyo (JP); Doni Daniel, Gants Hill (GB); William Lee, Lyme Regis (GB); Noppong Worapipat, Chonburi (TH)

(21) Appl. No.: 17/624,602

(22) PCT Filed: Jul. 2, 2020
(86) PCT No.: PCT/EP2020/068607

§ 371 Date: Jan. 4, 2022

(30) Foreign Application Priority Data
Jul. 4, 2019 (GB) 1909636.1

(51) Int. Cl. C04B 41/50; C04B 28/34; C04B 14/06; C04B 14/30; C04B 41/00; C04B 41/45; C04B 41/52; C04B 41/87; C04B 41/89

(52) U.S. Cl. CPC C04B 41/5092; C04B 28/344; C04B 14/06; C04B 14/308; C04B 14/30; C04B 41/009; C04B 2111/00577; C04B 41/0072; C04B 41/5035; C04B 41/522; C04B 41/87; C04B 41/89; C04B 41/4543

(57) ABSTRACT

The present invention relates to a coating composition comprising: 10 to 80 wt % of cerium oxide comprising a dopant based upon the total weight of the composition, wherein said dopant is selected from iron oxide, cobalt oxide, chromium oxide, lanthanum oxide, or mixtures thereof, and the atomic ratio of dopant metal to cerium is in the range 0.01:1 to 0.5:1; and 10 to 50 wt % of binder based upon the total weight of the composition.

### FIELD OF THE INVENTION

The present invention relates to a coating composition (e.g. a high emissivity coating composition), a kit and a method for making the composition, a method for coating substrates with the composition, and a substrate coated with the composition.

### BACKGROUND OF THE INVENTION

High emissivity coatings can be used to reduce energy and production costs in a petrochemical furnace. The high emissivity material is used to cover the inner surface of the furnace wall, enabling it to absorb and re-emit heat and thereby increase thermal efficiency. Conventionally, chromium oxide is used as a high emissivity coating in a steam cracking furnace, but it can only tolerate temperatures of 1100° C. or lower. Above this temperature, the high vapor pressure of chromium causes the coating material to become unstable and start to disintegrate, causing the rest to melt.

Cerium oxide is a rare earth based material which is chemically stable and has a good thermal resistance, making it suitable for high temperature applications in extreme environments (e.g. in a furnace).

WO2016082610A1 discloses a high temperature-, stain- and slagging-resistant ceramic coating, comprising the following components by mass percentage: 15-30% filler, 40-65% adhesive agent, and the balance being water, wherein the filler comprises 3-5% of zirconia, 3-5% silicon carbide, 3-5% silicon nitride, 1-3% titanium oxide, 2-4% kaolin and 3-8% rare earth oxide. The rare earth oxide is a mixture of yttrium oxide, cerium oxide and europium oxide.

U.S. Pat. No. 5,668,072A discloses a high emissivity coating composition for coating the interior of a furnace which operates above 1100° C. The preferred composition comprises cerium oxide and a binder agent. However, the composition gives low emissivity at wavelengths shorter than 5 micron.

### SUMMARY OF THE INVENTION

Viewed from a first aspect, the present invention provides a coating composition comprising:
10 to 80 wt % of cerium oxide comprising a dopant based upon the total weight of the composition, wherein said dopant is selected from iron oxide, cobalt oxide, chromium oxide, lanthanum oxide, or mixtures thereof and the atomic ratio of dopant metal to cerium is in the range 0.01:1 to 0.5:1; and
10 to 50 wt % of binder based upon the total weight of the composition.

Preferred coating compostions of the invention further comprise an emissivity agent.

Viewed from a further aspect, the present invention provides a package containing a coating composition as hereinbefore described.

Viewed from a further aspect the present invention provides a kit for preparing a coating composition as hereinbefore described comprising:
(i) a first container containing cerium oxide comprising a dopant, wherein said dopant is selected from iron oxide, cobalt oxide, chromium oxide, lanthanum oxide, or mixtures thereof, and the atomic ratio of dopant metal to cerium is in the range 0.01:1 to 0.5:1; and
(ii) instructions to mix said cerium oxide comprising a dopant with a binder.

Viewed from a further aspect, the present invention provides a method for preparing a coating composition as hereinbefore defined, comprising the steps of:
i) doping cerium oxide with a dopant selected from iron oxide, cobalt oxide, chromium oxide, lanthanum oxide, or mixtures thereof, to give cerium oxide comprising a dopant; and
ii) mixing said cerium oxide comprising a dopant with a binder.

Viewed from a further aspect, the present invention provides a method for preparing a coated substrate, comprising the steps of:
a) providing a substrate;
b) applying a coating composition as hereinbefore described onto at least one surface of said substrate; and
c) heating said coating composition to form the coated substrate.

Viewed from a further aspect, the present invention provides a coated substrate obtainable by or obtained by the method as hereinbefore described.

Viewed from a further aspect, the present invention provides a coated substrate comprising or derived from a composition as hereinbefore described.

Viewed from a further aspect, the present invention provides a coated substrate, wherein said coating comprises:

10 to 80 wt % of cerium oxide comprising a dopant based upon the total weight of the coating, wherein said dopant is selected from iron oxide, cobalt oxide, chromium oxide, lanthanum oxide, or mixtures thereof and the atomic ratio of dopant metal to cerium is in the range 0.01:1 to 0.5:1; and

20 to 55 wt % of binder, based upon the total weight of the coating.

Viewed from a further aspect, the present invention provides a furnace comprising a coated substrate as hereinbefore described.

Viewed from a further aspect, the present invention provides the use of a coating composition as hereinbefore described to coat a substrate.

### Definitions

As used herein, the term “dopant” refers to a trace compound that is incorporated into a substance in low concentrations to alter the electrical or optical properties of the substance. The cerium oxide comprising a dopant present in the compositions of the invention may, for example, comprise up to 50 wt % dopant, based on the total weight of the cerium oxide comprising a dopant. Preferably the cerium oxide comprising a dopant comprises 40 wt % or less dopant, based on the total weight of the cerium oxide comprising a dopant.

As used herein, the term “binder” refers to a material or substance that holds or draws other materials together.

As used herein, the term “wt %” is based on the total weight of the composition, unless otherwise specified.

As used herein, the term “dry wt %” is based on the total weight of the non-liquid compounds of the composition, e.g. excluding water.

As used herein, the term “emissivity” refers to the effectiveness of a material to emit energy as thermal radiation. Emissivity is typically measured using an emissometer.

As used herein, the term “emissivity agent” refers to a material that increases the emissivity of a coating composition to which it is added.

As used herein, the term “filler” refers to a material that increases the resistance to stress and thermal stress of high emissivity coating compositions.

As used herein, the term “heating” includes heating and heat-treating.

### DETAILED DESCRIPTION OF THE INVENTION

The present invention provides a coating composition comprising: 10 to 80 wt % of cerium oxide comprising a dopant based upon the total weight of the composition, wherein said dopant is selected from iron oxide, cobalt oxide, chromium oxide, lanthanum oxide, or mixtures thereof; and 10 to 50 wt % of binder based upon the total weight of the composition.

The present invention advantageously provides a high emissivity coating composition that can withstand temperatures higher than 1100° C. and also possess a high emissivity of at least 0.9 over a wide wavelength range at temperatures higher than 1100° C. These properties make the coating compositions of the present invention particularly suitable for coating the inner surfaces of furnaces in order to increase their thermal efficiency.

Preferred compositions of the present invention comprise 10 to 70 wt % of cerium oxide comprising a dopant based upon the total weight of the composition, more preferably 10 to 60 wt % (e.g. 40 to 60 wt %), still more preferably 10 to 45 wt %.

Preferred compositions of the present invention comprise 10 to 45 wt % of binder based upon the total weight of the composition, more preferably 10 to 40 wt %.

The total weight of all of the ingredients of the composition of the present invention is 100 wt %.

Preferably, the atomic ratio of dopant metal to cerium is in the range of 0.01:1 to 0.5:1, more preferably 0.01:1 to 0.3:1, even more preferably 0.01:1 to 0.25:1, yet more preferably 0.01:1 to 0.2:1 and still more preferably 0.05:1 to 0.2:1.

In preferred compositions of the present invention, the cerium oxide comprising a dopant comprises 0.4-50 wt %, more preferably 0.4-37 wt %, even more preferably 0.4-32 wt %, yet more preferably 0.4-28 wt % (e.g. 2-28 wt % wt %) of a dopant based upon the total weight of the cerium oxide comprising a dopant. When the dopant is cobalt oxide, particularly preferred compositions of the invention comprise 0.4 to 28 wt %, preferably 0.4-25 wt % and still more preferably 0.4-18 wt % of dopant, based upon the total weight of the cerium oxide comprising a dopant. When the dopant is iron oxide or chromium oxide, particularly preferred compositions of the invention comprise 0.4 to 37 wt %, preferably 0.5-35 wt % and still more preferably 0.7-32 wt % of dopant, based upon the total weight of the cerium oxide comprising a dopant. When the dopant is lanthanum oxide, particularly preferred compositions of the invention comprise 1.0 to 50 wt %, preferably 1.5-50 wt % and still more preferably 1.75-49 wt % of dopant, based upon the total weight of the cerium oxide comprising a dopant.

In preferred compositions of the present invention, the dopant is selected from iron oxide, cobalt oxide, chromium oxide, or mixtures thereof. In further preferred compositions, the dopant is iron oxide (Fe₂O₃). In alternative preferred compositions, the dopant is cobalt oxide (CoO).

Preferably, the binder is an aluminum phosphate inorganic binder. Suitable binders include, but are not limited to, phosphoric acid (H₃PO₄), a sodium aluminosilicate and/or a potassium aluminosilicate to form, for instance, Al₂(H₂P₂O₇), Al(PO₃)₃, AlPO₄, and/or KAlSi₃O₈.

Preferred coating compositions of the present invention further comprise water. Preferred coating compositions of the present invention further comprise 10 to 40 wt % water, and more preferably 20 to 30 wt % water (e.g. 25 wt %).

Particularly preferred coating compositions of the present invention comprise:

40 to 60 wt % of cerium oxide comprising a dopant based upon the total weight of the composition, wherein said dopant is selected from iron oxide, cobalt oxide, chromium oxide, lanthanum oxide, or mixtures thereof;
10 to 40 wt % of binder based upon the total weight of the composition; and
10 to 40 wt % water based upon the total weight of the composition.

Preferred coating compositions of the present invention further comprise at least one emissivity agent. Preferably, the coating compositions comprise 2 to 60 wt %, more preferably 5 to 50 wt %, even more preferably 5 to 40 wt % (e.g. 35 wt %) of at least one emissivity agent, based upon the total weight of the coating composition.

Preferred emissivity agents include, but are not limited to, titanium dioxide (TiO₂), silicon carbide (SiC), chromium oxide (Cr₂O₃), silicon dioxide (SiO₂), iron oxide (Fe₂O₃), boron silicide (B₄Si), boron carbide (B₄C), silicon tetraboride (SiB₄), molybdenum disilicide (MoSi₂), tungsten disilicide (WSi₂), and zirconium diboride (ZrB₂), or mixtures thereof.

Particularly preferred coating compositions of the present invention comprise:

10 to 45 wt % of cerium oxide comprising a dopant based upon the total weight of the composition, wherein said dopant is selected from iron oxide, cobalt oxide, chromium oxide, lanthanum oxide, or mixtures thereof;
10 to 40 wt % of binder based upon the total weight of the composition;
5 to 40 wt % of at least one emissivity agent based upon the total weight of the composition; and
10 to 40 wt % water based upon the total weight of the composition.

Preferred coating compositions of the present invention further comprise at least one filler. Preferably, the coating compositions comprise 5 to 50 wt %, more preferably 5 to 40 wt %, still more preferably 5 to 35 wt %, and still more preferably 8 to 30 wt % of at least one filler, based upon the total weight of the coating composition.

Fillers are materials that increase the resistance to stress and thermal stress of high emissivity coating compositions. Preferred fillers include, but are not limited to, alumina, silica, ceramic borides, ceramic carbides, ceramic nitrides, or mixtures thereof.

Particularly preferred coating compositions of the present invention comprise:

10 to 45 wt % of cerium oxide comprising a dopant based upon the total weight of the composition, wherein said dopant is selected from iron oxide, cobalt oxide, chromium oxide, lanthanum oxide, or mixtures thereof;
10 to 40 wt % of binder based upon the total weight of the composition;
5 to 40 wt % of at least one emissivity agent based upon the total weight of the composition;
5 to 35 wt % of at least one filler based upon the total weight of the composition; and
10 to 40 wt % water based upon the total weight of the composition.

The coating compositions of the present invention are high emissivity coating compositions, meaning that they are able to efficiently absorb and re-emit heat. The coating compositions of the present invention therefore preferably produce coatings having an emissivity of 0.85 to 0.98, more preferably 0.90 to 0.98, even more preferably 0.95 to 0.98 in the wavelength range of 1-25 μm. Emissivity is preferably tested according to the method described in the examples section herein, e.g. at a temperature of 600° C., 900° C., 1200° C. and/or 1600° C.

The coating compositions of the present invention also possess the other properties necessary to function as high emissivity coatings, e.g. thermal shock resistance, abrasion resistance and adhesion.

The present invention also provides a package containing a coating composition as hereinbefore described. Packages of the present invention include containers, drums, bottles, boxes, tins, jars, sachets etc.

The present invention also provides a kit for preparing a coating composition as hereinbefore described comprising:
(i) a first container containing cerium oxide comprising a dopant, wherein said dopant is selected from iron oxide, cobalt oxide, chromium oxide, lanthanum oxide, or mixtures thereof, and the atomic ratio of dopant metal to cerium is in the range 0.01:1 to 0.5:1; and
(ii) instructions to mix said cerium oxide comprising a dopant with a binder.

Preferred kits further comprise a second container containing binder.

The present invention also provides a method for preparing a coating composition as hereinbefore defined, comprising the steps of:
i) doping cerium oxide with a dopant selected from iron oxide, cobalt oxide, chromium oxide, lanthanum oxide, or mixtures thereof, to give cerium oxide comprising a dopant; and
ii) mixing said cerium oxide comprising a dopant with a binder.

Preferably, step (i) comprises grinding the cerium oxide and dopant together (e.g. by ball milling) and drying the resultant mixture, preferably at a temperature of 100 to 120° C. Preferably, the cerium oxide and dopant are ground to a particle size of less than 150 μm, more preferably less than 100 μm. Even more preferably, the cerium oxide and dopant are ground to a particle size in the range of 10 to 60 μm, most preferably in the range of 20 to 60 μm. Such particle sizes provide the coating produced from the coating composition with good mechanical properties.

The present invention also provides a method for preparing a coated substrate, comprising the steps of:

a) providing a substrate;

b) applying a coating composition as hereinbefore described onto at least one surface of said substrate; and

c) heating said coating composition to form the coated substrate.

In preferred methods of the invention the substrate is selected from at least one of a silica insulating brick, ceramic fiber, ceramic module, refractory brick, plastic refractory, castable refractory, refractory mortar, fiberlite, ceramic tiles, an array of fiber board, and metal. The substrate may be an inner lining, structure and/or part of a furnace (e.g. a cracking furnace), a fire heater, preheater, reformer, other refractory equipment in the field, ceramic automotive parts, refractory aerospace parts, or marine parts that are subjected to high temperature when in use. In preferred methods of the invention the coating and heating step is carried out on a refractory in situ in a furnace.

In preferred methods of the invention, the substrate is a refractory, preferably a plastic refractory. Plastic refractories are mixtures of refractory materials prepared in a stiff plastic condition for application without further preparation. They are generally rammed in place with a pneumatic hammer or pounded with a mallet. Due to their low porosity, plastic refractories are easily adaptable for making quick, economical, emergency repairs and can be rammed to any shape or contour.

In preferred methods of the invention, the substrate has a primer coating (i.e. an undercoat layer). Primer coatings work to improve the thermal insulation of the final coating composition. Preferably, the primer used to form the primer coating comprises a mixture of silicon oxide and silica aerogel. Preferably, the primer used to form the primer coating comprises a mixture of silicon oxide and silica aerogel in a weight ratio of 9:1 to 1:1, more preferably 8:2 to 4:6 (e.g. 8:2). Preferably, the primer used to form the primer coating composition further comprises an aluminium phosphate solution.

In preferred methods of the invention, the coating composition is applied in step (b) by a method selected from spray coating, brush coating, dip coating or combinations thereof. More preferably, the coating composition is applied in step (b) by spray coating, even more preferably by air spray coating or airless spray coating.

In preferred methods of the invention, step (c) provides a layer of coating composition having a thickness of 100 to 300 μm, more preferably 150 to 250 μm (e.g. 200 μm).

In preferred methods of the invention, the step (c) heating is at a temperature of 500° C. to 1700° C., more preferably 1000° C. to 1500° C. (e.g. 1200° C.).

In preferred methods of the invention, the step (c) heating is for 1 to 5 hours, more preferably 1 to 4 hours (e.g. 2 hours).

The heating step (c) employed in the methods of the invention preferably removes water from the coating composition (e.g. by evaporation).

Preferred compositions of the present invention comprise 10 to 80 dry wt % of cerium oxide comprising a dopant based upon the total dry weight of the composition (e.g. 53 to 80 dry wt %), more preferably 10 to 70 dry wt %, still more preferably 13.3 to 60 dry wt %.

Preferred compositions of the present invention comprise 20 to 55 dry wt % of binder based upon the total dry weight of the composition, more preferably 20 to 50 dry wt %. Suitable binders are as hereinbefore described.

Particularly preferred coating compositions of the present invention comprise:

53 to 80 dry wt % of cerium oxide comprising a dopant based upon the total dry weight of the composition, wherein said dopant is selected from iron oxide, cobalt oxide, chromium oxide, lanthanum oxide, or mixtures thereof; and
20 to 50 dry wt % of binder based upon the total dry weight of composition.

Preferred coating compositions of the present invention further comprise at least one emissivity agent as hereinbefore described. Preferably, the coating compositions comprise 2 to 60 dry wt %, more preferably 5 to 55 dry wt %, even more preferably 6.7 to 53.3 dry wt % (e.g. 50 dry wt %) of at least one emissivity agent, based upon the total dry weight of the composition.

Particularly preferred coating compositions of the present invention comprise:

13.3 to 60 dry wt % of cerium oxide comprising a dopant based upon the total dry weight of the composition, wherein said dopant is selected from iron oxide, cobalt oxide, chromium oxide, lanthanum oxide, or mixtures thereof;
20 to 50 dry wt % of binder based upon the total dry weight of the composition;
6.7 to 53.3 dry wt % of at least one emissivity agent based upon the total dry weight of the composition.

Preferred coating compositions of the present invention further comprise at least one filler as hereinbefore described. Preferably, the coating compositions comprise 5 to 60 dry wt %, more preferably 5 to 50 dry wt %, still more preferably 6.7 to 46.7 dry wt % of at least one filler, based upon the total dry weight of the composition.

Particularly preferred coating compositions of the present invention comprise:

13.3 to 60 dry wt % of cerium oxide comprising a dopant based upon the total dry weight of the composition, wherein said dopant is selected from iron oxide, cobalt oxide, chromium oxide, lanthanum oxide, or mixtures thereof;
20 to 50 dry wt % of binder based upon the total dry weight of the composition;
6.7 to 53.3 dry wt % of at least one emissivity agent based upon the total dry weight of the composition; and
6.7 to 46.7 dry wt % of at least one filler based upon the total dry weight of the composition.

A preferred method of the present invention comprises the steps of:

a) providing a substrate;

ai) applying a primer onto at least one surface of said substrate;

aii) drying said primer to give a substrate having a primer coating;

b) applying a coating composition as hereinbefore defined onto said primer coating of said substrate having a primer coating; and

c) heating said coating composition to form the coated substrate.

In preferred methods of the present invention, the primer comprises a mixture of silicon oxide and silica aerogel. More preferably, the ratio of silicon oxide and silica aerogel in the mixture of silicon oxide and silica aerogel is 9:1 to 1:1, more preferably 8:2 to 4:6 (e.g. 8:2).

Preferably, the primer further comprises an aluminium phosphate solution.

Preferably, the primer comprises 10 to 50 wt % of aluminium phosphate solution based upon the total weight of the primer and 50 to 90 wt % of a mixture of silica oxide and silica aerogel based upon the total weight of the primer. More preferably, the primer comprises 25 to 50 wt % of aluminium phosphate solution based upon the total weight of the primer and 50 to 75 wt % of a mixture of silica oxide and silica aerogel based upon the total weight of the primer. For example, said primer preferably comprises 50 wt % of aluminium phosphate solution based upon the total weight of the primer and 50 wt % of a mixture of silica oxide and silica aerogel based upon the total weight of the primer.

In preferred methods of the invention, the primer in step (ai) is applied by a method selected from spray coating, brush coating, dip coating or combinations thereof. More preferably, the primer in step (ai) is applied by spray coating, even more preferably by air spray coating.

In preferred methods of the invention, step (aii) provides a layer of primer having a thickness of 100 to 300 μm, more preferably 150 to 250 μm (e.g. 200 μm).

In preferred methods of the invention, the step (aii) drying is at room temperature.

In preferred methods of the invention, the step (aii) drying is for 0.5 to 5 hours, more preferably 1 to 4 hours (e.g. 2 hours).

In preferred methods of the invention, the step (c) heating is at a temperature of 500° C. to 1700° C., more preferably 1000° C. to 1500° C. (e.g. 1200° C.).

In preferred methods of the invention, the step (c) heating is for 1 to 5 hours, more preferably 1.5 to 4 hours (e.g. 2 hours).

In preferred methods of the invention, the coating composition in step (b) is applied by a method selected from spray coating, brush coating, dip coating or combinations thereof. More preferably, the coating composition in step (b) is applied by spray coating, even more preferably by air spray coating.

In preferred methods of the invention, step (c) provides a layer of coating composition having a thickness of 100 to 300 μm, more preferably 150 to 250 μm (e.g. 200 μm).

The present invention also provides a coated substrate obtainable by or obtained by a method as hereinbefore described.

The present invention also provides a coated substrate comprising a composition as hereinbefore described.

The present invention also provides a coated substrate, wherein the coating comprises:

10 to 80 wt % of cerium oxide comprising a dopant based upon the total weight of the coating, wherein said dopant is selected from iron oxide, cobalt oxide, chromium oxide, lanthanum oxide, or mixtures thereof and the atomic ratio of dopant metal to cerium is in the range 0.01:1 to 0.5:1; and

20 to 55 wt % of binder, based upon the total weight of the coating.

Preferred coatings comprise 53 to 80 wt %, more preferably 10 to 70 wt % and still more preferably 13.3 to 60 wt % of cerium oxide, based on the total weight of the coating.

Preferred dopants and amounts of dopants are as set out above in relation to the coating compositions. Preferred atomic ratios of dopant metal to cerium are as set out above in relation to the coating compositions.

Preferred coatings of the present invention comprise 20 to 50 wt % binder based upon the total weight of the coating. Suitable binders are as hereinbefore described.

Particularly preferred coatings of the present invention comprise:

53 to 80 wt % of cerium oxide comprising a dopant based upon the total weight of the coating, wherein said dopant is selected from iron oxide, cobalt oxide, chromium oxide, lanthanum oxide, or mixtures thereof; and
20 to 50 wt % of binder based upon the total weight of coating.

Preferred coatings of the present invention further comprise at least one emissivity agent as hereinbefore described. Preferably, the coatings comprise 2 to 60 wt %, more preferably 5 to 55 wt %, even more preferably 6.7 to 53.3 wt % (e.g. 50 wt %) of at least one emissivity agent, based upon the total weight of the coating.

Particularly preferred coatings of the present invention comprise:

13.3 to 60 wt % of cerium oxide comprising a dopant based upon the total weight of the coating, wherein said dopant is selected from iron oxide, cobalt oxide, chromium oxide, lanthanum oxide, or mixtures thereof;
20 to 50 wt % of binder based upon the total weight of the coating;
6.7 to 53.3 wt % of at least one emissivity agent based upon the total weight of the coating.

Preferred coatings of the present invention further comprise at least one filler as hereinbefore described. Preferably, the coating comprises 5 to 60 wt %, more preferably 5 to 50 wt %, still more preferably 6.7 to 46.7 wt % of at least one filler, based upon the total weight of the coating.

Particularly preferred coatings of the present invention comprise:

13.3 to 60 wt % of cerium oxide comprising a dopant based upon the total weight of the coating, wherein said dopant is selected from iron oxide, cobalt oxide, chromium oxide, lanthanum oxide, or mixtures thereof;
20 to 50 wt % of binder based upon the total weight of the coating;
6.7 to 53.3 wt % of at least one emissivity agent based upon the total weight of the coating; and
6.7 to 46.7 wt % of at least one filler based upon the total weight of the coating.

Preferred coated substrates include coated refractories, more preferably coated refractories selected from silica insulating brick, ceramic fiber, ceramic module, refractory brick, plastic refractory, castable refractory, refractory mortar, fiberlite, ceramic tiles, an array of fiber board, and metal.

The present invention also provides a furnace comprising a coated substrate as hereinbefore described.

The present invention also provides the use of a coating composition as hereinbefore described to coat a substrate.

It will be appreciated that, although specific embodiments of the present invention have been described herein for the purposes of illustration, various modifications may be made without departing from the scope of the disclosure. Accordingly, the disclosure is not limited except as by the appended claims.

In the following section, further advantages and features of the present invention are illustrated by way of examples.

### BRIEF DESCRIPTION OF THE FIGURES

FIG. 1 is an optical photograph of the cross-section of the coated sample prepared according to the Example 4 described below.

FIG. 2 is an optical photograph of the top surface of the coated samples prepared according to Example 2 and Example 4 described below.

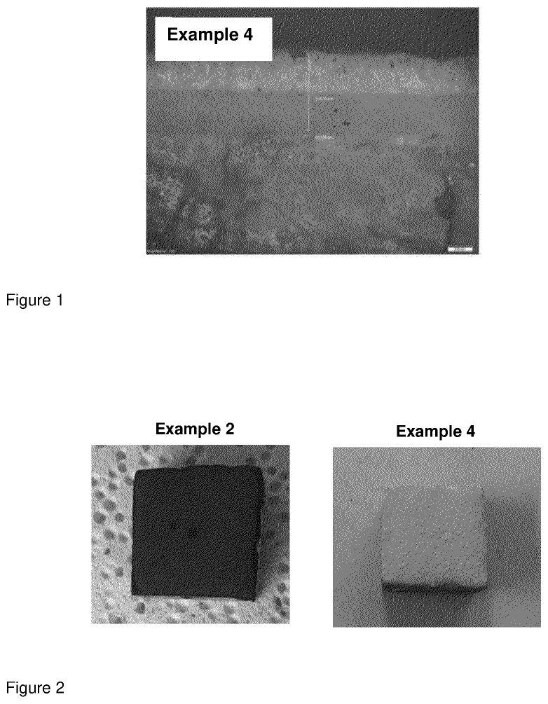

### EXAMPLES

### Materials

All starting materials were commercially available from Sigma Aldrich.

### Measurement Methods

Emissivity was measured at temperatures of 600° C., 900° C., 1300° C. and 1600° C. using an FTIR infrared emissometer, modified to include a computer-controlled circular turntable equipped with a blackbody reference and an integrated axisymmetric heating system based on a CO₂ laser. During measurement, a sample is heated by the CO₂ laser, causing it to radiate. This radiation/emission is detected by the FTIR instrument. The spectral emissivity is determined by calculating the ratio of the sample spectral emittance intensity and the blackbody spectral emittance intensity.

### Preparatory Example: Preparation of a Primer Coating

Silicon oxide and silica aerogel were mixed together in a weight ratio of 8:2. Then, a primer was prepared by mixing 50 wt % of the silicon oxide/silica aerogel mixture with 50 wt % of an aluminium phosphate solution containing 50% v/v aluminium phosphate.

A plastic refractory, which was prepared by mold casting to a size of 115×76×25 mm, was used as a substrate. Before being coated with the primer, the substrate was dried under atmospheric conditions overnight and was then heat-treated at 1500° C. for 2 hours. The substrate was then cooled to room temperature before coating.

The coating solution was sprayed on the cooled substrate by spray coating to a thickness of 300 μm. It was then dried at room temperature for 30 minutes to obtain the primer-coated substrate.

### Preparation of Non-Doped Cerium Oxide

### Comparative Example 1

A coating solution was prepared by mixing 50 wt % of cerium oxide (CeO₂) powder with 50 wt % of an aqueous aluminium phosphate solution containing 50% v/v aluminium phosphate.

The non-doped cerium oxide coating solution was directly sprayed to 300 μm thickness on a primer-coated substrate prepared according to the Preparatory Example. The coated specimen was then sintered for 3 hr at 1200° C. with heating rate of 1° C./min.

The emissivity of the coated substrate was measured according to the method described above.

The non-doped CeO₂ coating was found to show high emissivity in the range of 0.8-0.98 in mid-infrared wavelengths (i.e. 5-25 μm) at both 1300° C. and 1600° C.; however, in near-infrared wavelengths (i.e. below 5 μm), the emissivity dropped to around 0.22 at both temperatures.

### Preparation of Doped Cerium Oxide

### Example 2

A mixture of 84.3 wt % cerium oxide (CeO₂) powder and 15.7 wt % iron oxide (Fe₂O₃) (i.e. an atomic ratio of 1:0.2) was prepared, wherein the wt % values are based upon the total weight of the mixture. The mixed composition was grinded and mixed by ball milling. Then, the ball was removed and the composition was dried at 110° C. overnight to obtain the mixed composition in powder.

A coating solution was prepared by mixing 50 wt % of the powder with 50 wt % of an aqueous aluminium phosphate solution containing 50% v/v aluminium phosphate.

The Fe₂O₃-doped cerium oxide coating solution was directly sprayed to 300 μm thickness on a primer-coated substrate prepared according to the Preparatory Example. The coating specimen was then sintered for 3 hr at 1200° C. with heating rate of 1° C./min.

The emissivity of the coated substrate was measured according to the method described above.

The Fe₂O₃-doped CeO₂ coating was found to show an increased emissivity with increasing temperature. The emissivity of the Fe₂O₃-doped CeO₂ coating at 600° C. increased by 45% based on the emissivity at 300° C. and reached the emissivity value of 0.90-0.98 at temperatures of 1300° C. and 1600° C. across the whole wavelength range (1-25 μm).

### Example 3

A mixture of 92.0 wt % cerium oxide powder and 8.0 wt % cobalt oxide (CoO) (i.e. an atomic ratio of 1:0.2) was prepared, wherein the wt % values are based upon the total weight of the mixture. The mixed composition was grinded and mixed by ball milling. Then, the ball was removed and the composition was dried at 110° C. overnight to obtain the mixed composition in powder.

A coating solution was prepared by mixing 50 wt % of the powder with 50 wt % of an aqueous aluminium phosphate solution containing 50% v/v aluminium phosphate.

The CoO-doped cerium oxide coating solution was directly sprayed to 300 μm thickness on a non-coated substrate. The coating specimen was then sintered for 3 hr at 1200° C. with heating rate of 1° C./min.

The emissivity of the coated substrate was measured according to the method described above.

The emissivity of the CoO-doped CeO₂ coating at 900° C. increased by 50% based on the emissivity at 600° C. and reached a saturation value at an emissivity of around 0.9 across the whole wavelength range (1-25 μm).

### Example 4

A mixture of 72.5 wt % cerium oxide (CeO₂) powder and 27.5 wt % lanthanum oxide (La₂O₃) (i.e. an atomic ratio of 1:0.2) was prepared, wherein the wt % values are based upon the total weight of the mixture. The mixed composition was grinded and mixed by ball milling. Then, the ball was removed and the composition was dried at 110° C. overnight to obtain the mixed composition in powder.

A coating solution was prepared by mixing 50 wt % of the powder with 50 wt % of an aqueous aluminium phosphate solution containing 50% v/v aluminium phosphate.

The La₂O₃-doped cerium oxide coating solution was directly sprayed to 300 μm thickness on a primer-coated substrate prepared according to the Preparatory Example. The coating specimen was then sintered for 3 hr at 1200° C. with heating rate of 1° C./min.

The appearance of all Examples was checked after sintering and in all cases it was found that the coating appeared dense and without cracks on the surface.

1. A coating composition comprising:
10 to 80 wt % of cerium oxide comprising a dopant based upon the total weight of the composition, wherein said dopant is selected from iron oxide, cobalt oxide, chromium oxide, lanthanum oxide, or mixtures thereof, and the atomic ratio of dopant metal to cerium is in the range 0.01:1 to 0.5:1; and
10 to 50 wt % of binder based upon the total weight of the composition.

2. The coating composition according to claim 1, comprising 10 to 70 wt % of cerium oxide comprising a dopant, and 10 to 45 wt % of binder.

3. The coating composition according to claim 1, wherein the dopant is iron oxide and/or cobalt oxide.

4. The coating composition according to claim 1, wherein the atomic ratio of dopant metal to cerium is in the range 0.05:1 to 0.5:1.

5. The coating composition according to claim 1, wherein said binder is an aluminum phosphate inorganic binder.

6. The coating composition according to claim 1, further comprising an emissivity agent and/or a filler.

7. The coating composition as claimed in claim 6, wherein said emissivity agent is selected from titanium dioxide (TiO₂), silicon carbide (SiC), chromium oxide (Cr₂O₃), silicon dioxide (SiO₂), iron oxide (Fe₂O₃), boron silicide (B₄Si), boron carbide (B₄C), silicon tetraboride (SiB₄), molybdenum disilicide (MoSi₂), tungsten disilicide (WSi₂), and zirconium diboride (ZrB₂), or mixtures thereof

8. The coating composition according to claim 1, which produces a coating having an emissivity of 0.85 to 0.98 in the wavelength range 1-25 μm.

9. (canceled)

10. (canceled)

11. (canceled)

12. (canceled)

13. A method for preparing a coated substrate, comprising the steps of:
a) providing a substrate, preferably selected from a silica insulating brick, ceramic fiber, ceramic module, refractory brick, plastic refractory, castable refractory, refractory mortar, fiberlite, ceramic tile, an array of fiber board, and metal;
b) applying a coating composition as defined in claim 1 onto at least one surface of said substrate; and
c) heating said coating composition to form the coated substrate.

14. The method according to claim 13, wherein step (c) heating is at a temperature of 500° C. to 1700° C. and/or wherein step (c) heating is for 1 to 5 hours.

15. The method according to claim 13, wherein the coating composition is applied in step (b) by a method selected from spray coating, brush coating, dip coating or combinations thereof, preferably spray coating (e.g. air spray coating).

16. The method according to claim 13, comprising the steps of:
a) providing a substrate, preferably selected from a silica insulating brick, ceramic fiber, ceramic module, refractory brick, plastic refractory, castable refractory, refractory mortar, fiberlite, ceramic tiles, and array of fiber board, and metal;
ai) applying a primer onto at least one surface of said substrate;
aii) drying said primer to give a substrate having a primer coating;
b) applying a coating composition as defined in claim 1 onto said primer coating of said substrate having a primer coating; and
c) heating said coating composition to form the coated substrate.

17. The method according to claim 16, wherein said primer comprises a mixture of silicon oxide and silica aerogel, preferably a mixture of silicon oxide and silica aerogel in a weight ratio of 9:1 to 1:1.

18. The method according to claim 16, wherein the step (c) heating is at a temperature of 500° C. to 1700° C. and/or wherein step (c) heating is for 1 to 5 hours.

19. (canceled)

20. (canceled)

21. A coated substrate, preferably a coated refractory, wherein said coating comprises:
10 to 80 wt % of cerium oxide comprising a dopant based upon the total weight of the coating, wherein said dopant is selected from iron oxide, cobalt oxide, chromium oxide, lanthanum oxide, or mixtures thereof, wherein the atomic ratio of dopant to cerium oxide is in the range 0.01:1 to 0.5:1, preferably 0.05:1 to 0.5:1; and
20 to 55 wt % of binder based upon the total weight of the coating.

22. The coated substrate as claimed in claim 21, wherein said coating further comprises an emissivity agent.

23. The coated substrate as claimed in claim 21, wherein said dopant is iron oxide and/or cobalt oxide.

24. The coated substrate according to claim 18, in a furnace.

25. (canceled)
